(19) United States
(12) Patent Application Publication
(10) Pub. No.: US 2004/0099246 A1
(43) Pub. Date: May 27, 2004

(54) Fuel injector with multiple control valves

(75) Inventor: DeForest C. Gould, Washington, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/301,674

(22) Filed: Nov. 22, 2002

(51) Int. Cl. F02M 47/02

(52) U.S. Cl. 123/446; 239/88; 239/585.1; 123/458

(57) ABSTRACT

A fuel injector includes a pressure chamber coupled to at least a first fuel path, a second fuel path, and a third fuel path. The first fuel path extends from the pressure chamber to a fuel sump and having a first head loss value. The second fuel path extends from the pressure chamber to the fuel sump and having a second head loss value greater than the first head loss value. The third fuel path extends from the pressure chamber to a nozzle tip of the injector and having a third head loss value greater than the first head loss value.

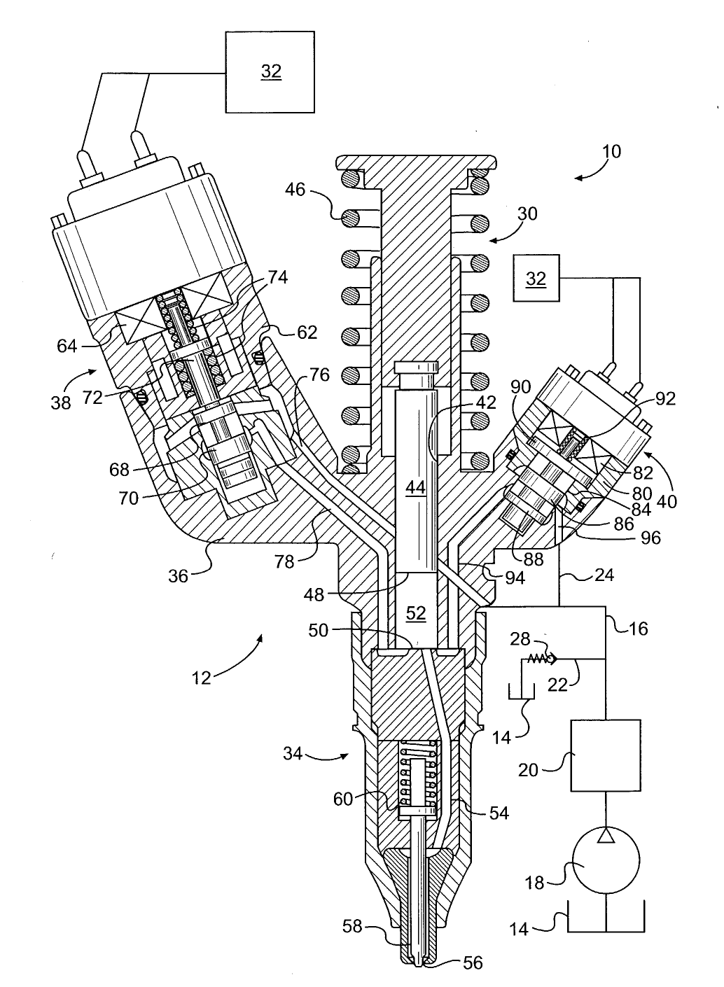

### TECHNICAL FIELD

This invention relates generally to internal combustion engines, and more particularly to a fuel injector for an internal combustion engine.

### BACKGROUND

In recent years, internal combustion engine manufacturers have been faced with ever increasing regulatory requirements. These requirements have been directed mainly at two aspects of engine performance, namely fuel economy and exhaust emissions. In an attempt to improve these two aspects of engine performance, engine manufactures have focused on various components of the engine system. For example, engine manufactures have attempted to redesign the operation and control of engine fuel systems to improve the fuel economy and emissions of the engine system.

U.S. Pat. No. 4,653,455 to Eblen et al. discloses a conventional mechanically actuated fuel injector for an internal combustion engine. The fuel injector includes a fuel plunger which acts to pressurize fuel received in a fuel pumping chamber of the injector. When the fuel plunger moves to reduce the volume of the fuel pumping chamber, fuel in the pumping chamber is pressurized. When the fuel is pressurized to a predetermined high pressure, corresponding to the valve opening pressure, the fuel acts to open a check valve located in the nozzle of the injector. Once the check valve is opened, fuel is able to travel through orifices located in the nozzle tip and into the combustion chamber. When the pressure of the fuel becomes less than the valve opening pressure, the check valve closes and the fuel injection ceases.

The fuel injector of the ′445 patent includes a solenoid actuated overflow valve fluidly connected to the fuel pumping chamber. When open, the overflow valve provides an alternate path for the high pressure fuel. The alternate path is configured so that when the overflow valve is open, the high pressure fuel cannot maintain the valve opening pressure. Accordingly, when the overflow valve is open, fuel cannot be injected into the combustion chamber.

This control of the flow of high pressure fuel allows for tailoring the quantity of fuel injected into the combustion chamber.

While the fuel injector of the ′455 patent provides some control over fuel injection, and is relatively inexpensive compared to more complex fuel injector arrangements, further control of fuel injection is required to improve fuel economy and emissions of the engine system. For example, the fuel injector of the ′455 patent cannot vary the rate at which fuel is injected into the combustion chamber. Accordingly, the present invention provides a fuel injector for an engine that avoids some or all of the aforesaid shortcomings in the prior art.

### SUMMARY OF THE INVENTION

In accordance with one aspect of the invention, a fuel injector includes a pressure chamber coupled to a first fuel path, a second fuel path, and a third fuel path. The first fuel path extends from the pressure chamber to a fuel sump and has a first head loss value. The second fuel path extends from the pressure chamber to the fuel sump and has a second head loss value greater than the first head loss value. The third fuel path extends from the pressure chamber to a nozzle tip of the injector and has a third head loss value greater than the first head loss value.

According to another aspect of the present invention, a method for varying an injection rate of a fuel injector includes forcing a portion of fuel located in a pressure chamber of the fuel injector to travel along a first fuel passage to exit a nozzle tip of the fuel injector, and selectively allowing a portion of fuel located in the pressure chamber to travel along a second fuel passage and exiting the fuel injector at the same time the fuel is exiting the nozzle tip.

According to yet another aspect of the present invention, a fuel system for an internal combustion engine includes a fuel sump and at least one fuel supply line connecting the fuel sump to at least one mechanically driven fuel injector. Each at least one fuel injector includes a pressure chamber coupled to at least a first fuel path, a second fuel path, and a third fuel path. The first fuel path extends from the pressure chamber to a fuel sump and has a first head loss value and a first valve assembly selectively blocking and unblocking the first fuel path. The second fuel path extends from the pressure chamber to the fuel sump and has a second head loss value greater than the first head loss value and a second valve assembly selectively blocking and unblocking the second fuel path. The third fuel path extends from the pressure chamber to a nozzle tip of the injector and has a third head loss value greater than the first head loss value.

It is to be understood that both the foregoing general description and the following detailed description are exemplary and explanatory only and are not restrictive of the invention, as claimed.

### BRIEF DESCRIPTION OF THE DRAWINGS

The figure is a partial section and diagrammatic view of a fuel system according to an exemplary embodiment of the present invention.

### DETAILED DESCRIPTION

The figure illustrates a portion of a fuel system 10 for supplying fuel to a combustion chamber of an internal combustion engine. While the present invention will be described in connection with a direct-injection dieselcycle reciprocating internal combustion engine, the present invention may be used with other types of engine systems, for example, rotary engines or modifiedcycle engines. Further, while the present invention will be described in connection with a single fuel injector 12, it is appreciated that the invention may be applied to multiple fuel injectors of an engine.

Fuel system 10 may include a fuel sump 14, such as a fuel tank, and a fuel supply line 16 connected between fuel sump 14 and fuel injector 12.

Fuel supply line 16 may include a low pressure fuel supply pump 18 and a fuel filter 20. A portion of fuel supply line 16 may be disposed in a cylinder head of the engine (not shown) or may be separate therefrom. Fuel system 10 may also include a plurality of fuel return or fuel spill lines 22, 24 returning fuel from fuel injector 12 to fuel sump 14. Fuel return line 22 may utilize a portion of fuel supply line 16 or may be independent therefrom. As illustrated in the figure, fuel line 16 and fuel return line 22 may include appropriate valving to ensure that return fuel does not flow back through fuel filter 20 and fuel supply pump 18. This may be achieved, for example, by including a one-way, spring biased check valve 28 in return line 22. One-way spring biased valve 28 may be tailored to remain closed during low pressure fuel supply flow, and to open during high pressure return fuel flow.

Fuel injector 12 may be driven by any suitable mechanism, for example, via a hydraulic, pneumatic or mechanical drive assembly. As illustrated in the figure, fuel injector 12 is mechanically driven and includes a tappet and plunger assembly 30 that is driven directly or indirectly by a conventional cam assembly (not shown). The cam assembly may include a cam lobe of an engine driven cam shaft, wherein the cam lobe may drive a pivoting rocker arm assembly which in turn reciprocates tappet and plunger assembly 30.

Fuel injector 12 may be coupled to receive signals from an electronic control module 32. Electronic control module 32, in turn, may receive signals from a plurality of sensors (not show) located throughout the engine for measuring various engine parameters.

Further, fuel injector 12 is illustrated as a unit injector having a single housing assembly for both pressurizing fuel to a high level (for example, 207 MPa (30,000 p.s.i.)) and injecting the pressurized fuel into an associated combustion chamber. Although shown as a single unit, fuel injector 12 may alternatively have a modular construction with the fuel injection component mechanically separate from the fuel pressurization component and connected by way of fluid conduits.

Fuel injector 12 may include a nozzle assembly 34, a barrel housing 36, a first valve assembly 38 and a second valve assembly 40. Barrel housing 36 may include a cylindrical opening 42 for receiving a plunger 44 of tappet and plunger assembly 30. Tappet and plunger assembly 30 may be biased by a compression spring 46 to urge plunger 44 in a proximal direction away from nozzle assembly 34. A portion of cylindrical opening 42 between a distal end 48 of plunger 44 and a proximal end 50 of nozzle assembly 34 forms a variable volume pressure chamber 52. When pressure chamber 52 is filled with fuel, driving plunger 44 in a distal direction toward nozzle assembly 34, corresponding to a plunger pressure stroke, acts to reduce the size of pressure chamber 52 and force the fuel from pressure chamber 52.

Nozzle assembly 34 may be formed in any conventional manner and may, for example, include a nozzle passage 54 extending from pressure chamber 52 to a nozzle tip 56. Nozzle assembly 34 may also include a spring biased nozzle valve member 58 for prohibiting pressurized fuel from exiting nozzle tip 56 until the pressure exerted by the fuel in nozzle passage 54 exceeds a predetermined valve opening pressure corresponding to a pressure greater than the biasing force of a compression spring 60 urging nozzle valve member 58 against nozzle tip 56.

First valve assembly 38 may include a first valve housing 62, a solenoid coil 64, and a spring biased poppet 66. Poppet 66 may include a first protruding land 68 and a second protruding land 70 and an armature portion 72. When first valve assembly 38 is in an open position, corresponding to the bias of a spring arrangement 74 and no current being supplied to solenoid coil 64, first protruding land 68 allows a first fuel line 76 to fluidly communicate with a second fuel line 78. When solenoid coil 64 of first valve assembly 38 is energized, second protruding land 70 blocks second fuel line 78 from fluidly communicating with first fuel line 76 and thus closes first valve assembly 38. It will be appreciated that first valve assembly 38 may be formed of any other conventional arrangement that permits controlled communication between first fuel line 76 and second fuel line 78.

Second valve assembly 40 may include the same or equivalent elements as first valve assembly 38. For example, second valve assembly 40 may include a second valve housing 80, a solenoid coil 82 and a spring biased poppet 84. Poppet 84 may include a first protruding land 86 and a second protruding land 88 and an armature portion 90. In contrast to first valve assembly 38, second valve assembly 40 is in a closed position when current is not supplied to solenoid coil 82. When second valve assembly 40 is in its closed position, corresponding to the bias of a spring arrangement 92, first protruding land 86 blocks a fuel return line 96 from fluidly communicating with a third fuel line 94. When solenoid coil 82 of second valve assembly 40 is energized to open the valve, first protruding land 86 no longer blocks fuel return line 96 and thereby allows fluid communication between third fuel line 94 and fuel return line 96. It will be appreciated that first valve assembly 40 may be formed of any other conventional arrangement that permits controlled communication between fuel return line 96 and third fuel line 94.

Fuel injector 12 detailed above forms three distinct fuel paths or passages connecting to pressure chamber 52. The first fuel path includes second fuel line 78, first valve assembly 38 and first fuel line 76. The second fuel path includes third fuel line 94, second valve assembly 40 and fuel return line 96. The third fuel path includes nozzle passage 54 extending to nozzle tip 56.

Each of the first, second and third fuel paths have a respective head loss value. The head loss value of each fuel path is a sum of all of the head losses of the respective fuel path during flow therethrough. For example, the third fuel path includes head losses resulting from flow through restrictions or clearances associated with flow around nozzle valve member 58 and through nozzle tip 56. Such head losses may result in a relatively large head loss value for the third fuel path. When first valve assembly 38 is open, the first fuel path does not include a substantial restriction relative to the restrictions and clearances associated with the third fuel path, and thus the first fuel path has a head loss value substantially lower than that of the third fuel path. The second fuel path, including second valve assembly 40 its open position, may be configured to provide restrictions and clearances forming in head losses that are approximately equal to the head losses formed in the third fuel path. Accordingly, second and third fuel paths may have approximately equal head loss values. Approximately equal head loss values, as defined herein, means that fluid forced from a common source, such as pressure chamber 52, into both the second and third flow paths would result in simultaneous flow through both paths. Approximately equal head loss values does not require that the same quantity of fuel exit each of the second and third fuel paths simultaneously. Further, it is understood that the head loss values in each of the first, second and third fuel paths are a byproduct of, inter alia, the size of the path and the size of the restrictions and clearances formed in the paths. Thus, the head loss values for the first, second and third fuel paths are design aspects that can be varied with different injectors.

Industrial Applicability

Referring to the figure, fuel injector 12 is shown with components positioned as they would be just prior to an injection event. In particular, solenoid coils 64 and 82 of first and second valve assemblies 38 and 40 are deenergized, nozzle valve member 58 is seated in nozzle tip 56, and plunger 44 is in its proximal-most position. In a de-energized state, first valve assembly 38 is in an open position allowing flow therethrough and second valve assembly is in a closed position prohibiting flow therethrough. Further, fuel injector 12 is primed with fuel so that fuel is maintained in each of first fuel line 76, second fuel line 78, pressure chamber 52, nozzle passage 54 and third fuel line 94.

Prior to and during an injection event, electronic control module 32 receives signals from sensors measuring various engine parameters. Based on the signals received, electronic control module 32 determines an appropriate fuel injection profile for an injection event of fuel injector 12. An appropriate fuel injection profile may take into account such factors as, engine power required, engine fuel efficiency, and engine emissions. For example, when electronic control module 32 receives signals indicative of a low engine speed and low engine load condition, electronic control module 32 selects a fuel injection profile that delivers a relatively small amount of fuel to the combustion chamber. Alternatively, when electronic control module 32 receives signals indicative of a high load and high speed condition of the engine, a fuel injection profile is selected that injects a relatively large amount of fuel to the combustion chamber.

Implementation of the appropriate fuel injection profile involves the selective energization of solenoid coils 64 and 82 of first and second valve assemblies 38, 40 prior to or during a pressure stroke of plunger 44. For example, during a high engine load, high engine speed condition, solenoid coil 64 of first valve assembly 38 may be energized to close first valve assembly 38 during the entire distal movement or pressure stroke of plunger 44. The fuel located in pressure chamber 52 is thus forced into nozzle assembly 34 through nozzle passage 54 and out nozzle tip 56 due to the fact that first and second valve assemblies 38, 40 are in a closed position. Once plunger 44 has traveled to its distal most-position, electronic control module 32 may de-energize solenoid coil 64 to open first valve assembly 38. With first valve assembly 38 in its open position, fuel may be pumped by supply pump 18 through first fuel line 76, first valve assembly 38, second fuel line 78, and into pressure chamber 52, as plunger 44 retracts in a proximal direction.

When the appropriate fuel injection profile dictates that not all of the fuel in pressure chamber 52 should be injected through nozzle assembly 34 and into the combustion chamber, electronic control module 32 delays energization of solenoid coil 64 of first valve assembly 38 while plunger 44 travels distally during its pressure stroke. During the delay, high pressure fuel travels along the first fuel path, namely from pressure chamber 52 through second fuel line 78, first valve assembly 38, and to first fuel line 76, and exists fuel injector 12 and travels through a portion of fuel line 16, to fuel supply return line 22, through spring biased valve 28, and back to fuel sump 14. Fuel does not flow out of the injector through nozzle tip 56 because, as noted above, the head loss value associated with the first fuel path through first valve assembly 38 is substantially less than the head loss value associated with the third fuel path through nozzle assembly 34. When electronic control module 32 determines that the remaining fuel in pressure chamber 52 should be injected through nozzle assembly 34 and into the combustion chamber, solenoid coil 64 of first valve assembly 38 is energized to close the valve and thus block fluid communication between first fuel line 76 and second fuel line 78. This results in almost immediate injection of fuel through nozzle tip 56 at the moment first valve assembly 38 is closed.

Accordingly, the timing of the closing of first valve assembly 38 prior to or during distal movement of plunger 44 determines the amount of fuel injected into the combustion chamber, the duration of the injection, and, to a certain extent the timing of the injection. The amount and duration of injection can range from a full quantity and duration, corresponding to energizing solenoid coil 64 of first valve assembly 38 during the entire distal movement of plunger 44, to a limited quantity and duration, corresponding to delayed energization of solenoid coil 64 until after plunger 44 has moved a certain distance distally. While closing first valve assembly 38 can modify the quantity and duration of fuel injected into the combustion chamber, closing cannot modify the rate of fuel injection. This fixed rate of injection is due to the complete diversion of high pressure fuel between the first fuel path and the third fuel path depending on the open or closed condition of first valve assembly 38. The actual rate of the fixed rate of injection is a function of the size of various components of fuel injector 12, such as the size of pressure chamber 52, nozzle passage 54 and nozzle tip 56.

It has been found, however, that it may be beneficial to vary the injection rate of the fuel into the combustion chamber between high load and low load engine conditions. For example, decreasing the rate of fuel injection into the combustion chamber at low engine loads, as compared to the injection rate at high engine loads, may reduce detrimental NOx emissions produced by the engine.

Opening of second valve assembly 40 while first valve assembly is closed and during distal movement of plunger 44 varies the rate of injection of fuel into the combustion chamber. As noted above, the second fuel path, including second valve assembly 40 when in its open position, forms a restricted path having a head losses approximating the head losses provided by the third fuel path. Thus, due to the approximately equal head loss values of the fuel paths through second valve assembly 40 and nozzle assembly 34, opening of second valve assembly causes fuel to flow through both nozzle assembly 34 and second valve assembly 40 simultaneously. Simultaneous flow of fuel through both the second valve assembly 40 and nozzle assembly 34 results in a slower rate of fuel injection through nozzle assembly 34 and into the combustion chamber, as compared to the injection rate if second valve assembly 40 were in its closed position.

Accordingly, when electronic control module 32 determines that a fuel injection profile should include fuel injection at a rate less than that of the fixed rate provided by flow along the third fuel path through nozzle assembly 34, a signal is sent to energize solenoid coil 64 of first valve assembly 38 and solenoid coil 82 of second valve assembly 40. Energization of the solenoid coils of first and second valve assemblies 38, 40 can take place simultaneously or at different times and prior to distal movement of plunger 44 or during movement of plunger 44. Once first valve assembly 38 is closed and second valve assembly 40 is opened, high pressure fuel flows from pressure chamber 52 through third fuel line 94, through second valve assembly 40 out fuel return line 96 and out of fuel injector 12 into fuel return line 24 to fuel sump 14. As noted above, fuel also travels through nozzle assembly 34 and out nozzle tip 56 into the combustion chamber. Once the desired quantity of fuel has been supplied to the combustion chamber, first valve assembly 38 may be de-energized and thus opened to cease further flow of fuel through nozzle assembly 34. It is noted that, due to the approximately equal head loss values of the fuel path through nozzle assembly 34 and second valve assembly 40, opening of first valve assembly 38 also halts the flow of fuel through second valve assembly 40.

The general operation of first valve assembly includes energization of solenoid coil 64 to attract armature 72 and move poppet 66 in a direction toward solenoid coil 64 to place the first valve assembly 38 in its closed position. De-energization of solenoid coil 64 allows poppet 66 to return to its original, open position due to the bias of spring assembly 74. Energization of solenoid coil 82 of second valve assembly 40 causes armature 90 to move toward solenoid coil 82 to place second valve assembly 40 it its open position and de-energization of solenoid coil 82 causes second valve assembly to return to its closed position.

Other embodiments of the invention will be apparent to those skilled in the art from consideration of the specification and practice of the invention disclosed herein. For example, first and second valve assemblies 38, 40 could be used in conjunction with a hydraulic or pneumatic driven fuel injector. Further, first solenoid valve 38 may be configured to open upon energization of solenoid coil 64 and close during de-energization. Alternatively, second valve assembly 40 may be configured to close upon energization of solenoid coil 82 and open when solenoid coil 82 is not energized. Even further, second valve assembly 40 may be configured to provide a variable head loss value for the second fuel path, wherein electronic control module 32 could control the head loss value of the second fuel path and thus further control the fuel injection rate into the combustion chamber. It is intended that the specification and examples be considered as exemplary only, with a true scope and spirit of the invention being indicated by the following claims.

What is claimed is:

1. A fuel injector comprising:
a pressure chamber coupled to a first fuel path, a second fuel path, and a third fuel path,
the first fuel path extending from the pressure chamber to a fuel sump and having a first head loss value,
the second fuel path extending from the pressure chamber to the fuel sump and having a second head loss value greater than the first head loss value, and
the third fuel path extending from the pressure chamber to a nozzle tip of the injector and having a third head loss value greater than the first head loss value.

2. The fuel injector of claim 1, wherein the first fuel path includes a controllable first valve assembly configured to selectively block and unblock the first fuel path.

3. The fuel injector of claim 2, wherein the second fuel path includes a controllable second valve assembly configured to selectively block and unblock the second fuel path.

4. The fuel injector of claim 3, wherein the first and second valve assemblies are controlled by an electronic control module.

5. The fuel injector of claim 4, wherein the first and second valve assemblies are moved between a first and second position upon energization of a solenoid.

6. The fuel injector of claim 1, wherein the second and third head loss values are approximately equal.

7. The fuel injector of claim 1, wherein a size of the pressure chamber is reduced by movement of a mechanically driven plunger.

8. A method for varying an injection rate of a fuel injector, comprising:
forcing a portion of fuel located in a pressure chamber of the fuel injector to travel along a first fuel passage to exit a nozzle tip of the fuel injector; and
selectively allowing a portion of fuel located in the pressure chamber to travel along a second fuel passage and exiting the fuel injector at the same time the fuel is exiting the nozzle tip.

9. The method according to claim 8, wherein the fuel injector is mechanically driven.

10. The method according to claim 8, wherein said step of selectively allowing fuel to travel along the second fuel passage includes selectively allowing fuel to flow through a valve assembly located in the second fuel passage.

11. The method according to claim 10, further including selectively controlling flow through a third fuel passage so that fuel flows only from the pressure chamber to a fuel sump.

12. A fuel system for an internal combustion engine, comprising:
a fuel sump; and
at least one fuel supply line connecting the fuel sump to at least one mechanically driven fuel injector,
each at least one fuel injector including a pressure chamber coupled to at least a first fuel path, a second fuel path, and a third fuel path,
the first fuel path extending from the pressure chamber to a fuel sump and having a first head loss value and a first valve assembly selectively blocking and unblocking the first fuel path,
the second fuel path extending from the pressure chamber to a fuel sump and having a second head loss value greater than the first head loss value and a second valve assembly selectively blocking and unblocking the second fuel path, and
the third fuel path extending from the pressure chamber to a nozzle tip of the injector and having a third head loss value greater than the first head loss value.

13. The fuel injector of claim 12, wherein the first and second valve assemblies are controlled by an electronic control module.

14. The fuel injector of claim 13, wherein the first and second valve assemblies are moved between a first and second position upon energization of a solenoid.

15. The fuel injector of claim 12, wherein the second and third head loss values are approximately equal.
